(19) United States
(12) Patent Application Publication
(10) Pub. No.: US 2011/0276388 A1
(43) Pub. Date: Nov. 10, 2011

(54) System and Method for Managing, Distributing, and Advertising a Plurality of Promotional Offers

(76) Inventor: Lawson DENG, Cupertino, CA (US)

(21) Appl. No.: 13/102,027

(22) Filed: May 5, 2011

Related U.S. Application Data
(60) Provisional application No. 61/331,719, filed on May 5, 2010.

(51) Int. Cl. G06Q 30/00

(52) U.S. Cl. 705/14.41; 705/14.4

(57) ABSTRACT

The present invention is a system and method for managing, distributing, and advertising a plurality of promotional offers. The promotional offers are deals such as coupons, gift certificates, and bargains. The present invention allows a plurality of advertisers to enter their promotional offer onto the present invention through an advertiser management infrastructure. The present invention distributes the promotional offers to a plurality of customers through a distribution infrastructure. The distribution infrastructure consists of a website, a mobile phone application, and a plurality of kiosks. The distribution infrastructure allows the plurality of customers to save, print, or share a particular promotional offer seen on the distribution infrastructure.

The current application claims a priority to the U.S. Provisional Patent application Ser. No. 61/331,719 filed on May 5, 2011.

### FIELD OF THE INVENTION

The present invention relates generally to managing, distributing, and advertising promotional offers through an integrated system including a plurality of kiosks, a website, or a mobile phone application.

### BACKGROUND OF THE INVENTION

Traditionally, consumers who wish to obtain coupon deals with local merchants either receives the coupons in regular mail, email, newspapers, or magazines. Other options for consumers to obtain coupon deals are to surf internet websites for coupons of promotional offers that interest them. These options of retrieving coupons can often times be tedious as the different promotional offers are scattered. This requires the consumer to place extra effort to find the promotional offer of their interest. Additionally, these methods often require the consumer to be readily prepare with the coupons before heading to the local retail destinations to redeem the value of the promotional offer. The present invention is a system that provides allows users to search for promotional offers in a centralized network. The users are provided means to access this network through a plurality of interfaces such as local kiosk stations positioned in a shopping center, a website that can be accessed through their own personal computers, or a mobile phone application.

### BRIEF DESCRIPTION OF THE DRAWINGS

FIG. 1 is a diagram of the main system and the users' interface.

FIGS. 2 and 3 is a flowchart illustrating the method of managing a plurality of pay per print campaigns.

FIG. 4 is a flowchart illustrating the method of the optimization algorithm.

FIG. 5 is a flowchart illustrating the method of logging into the main system and dealing with the plurality of promotional offers.

FIG. 6 is a flowchart illustrating the method of obtaining a selected promotional offer.

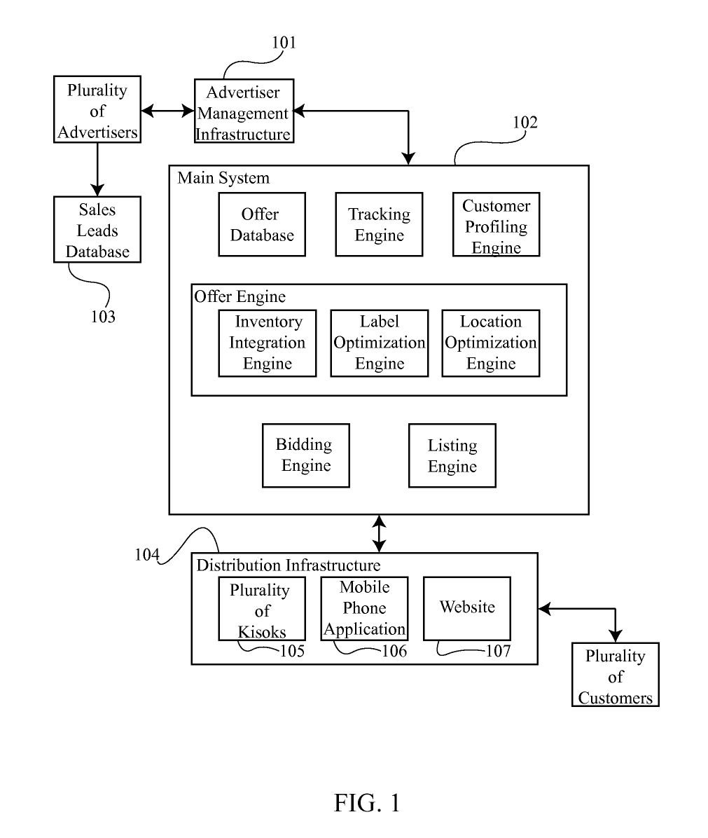

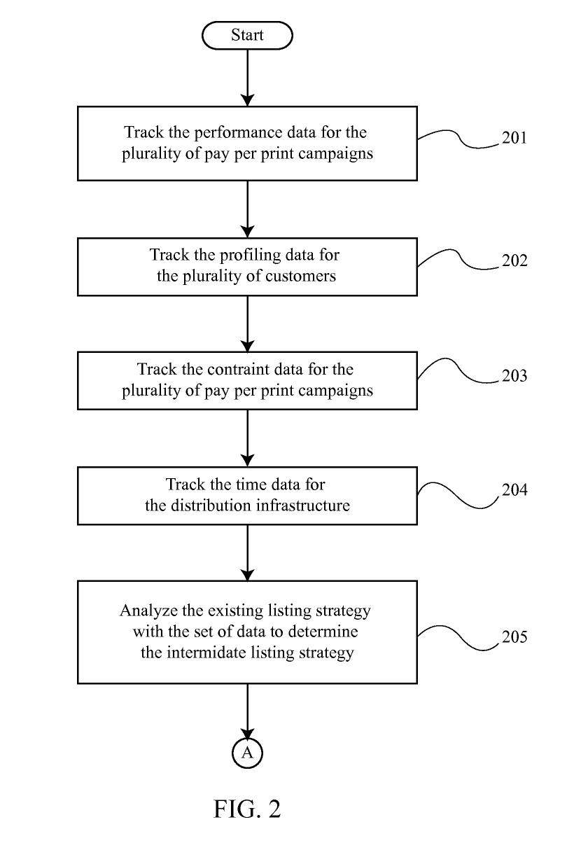

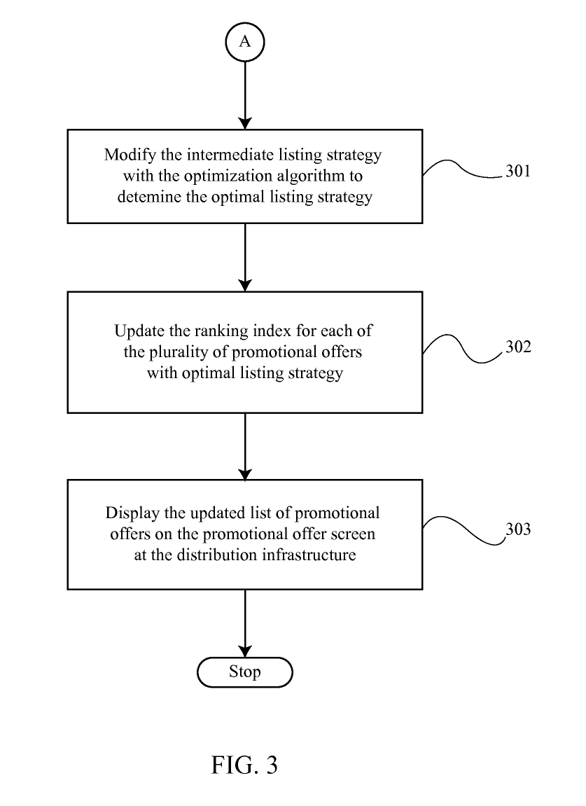

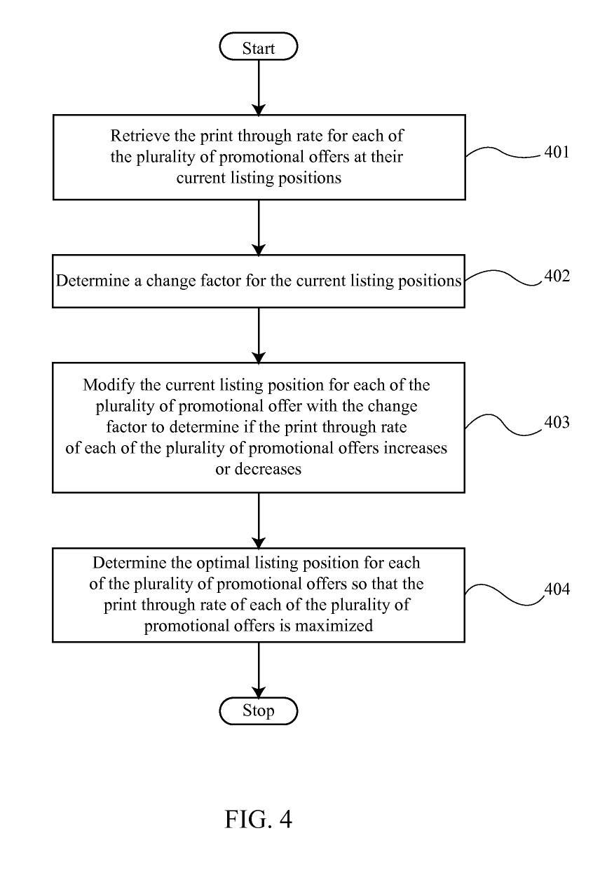

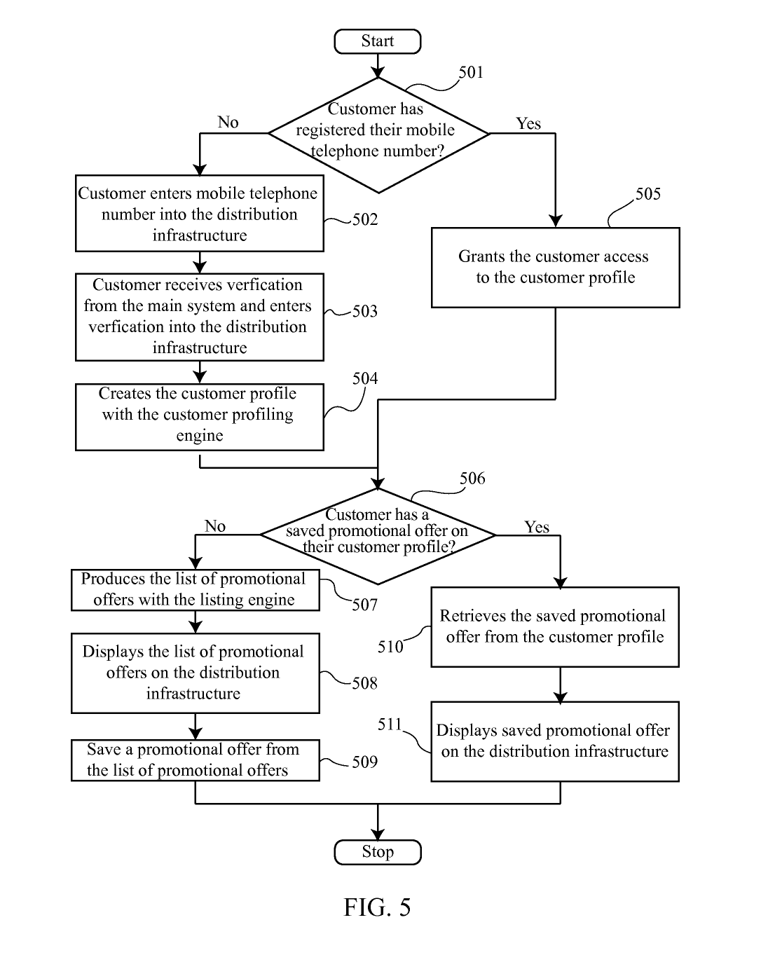

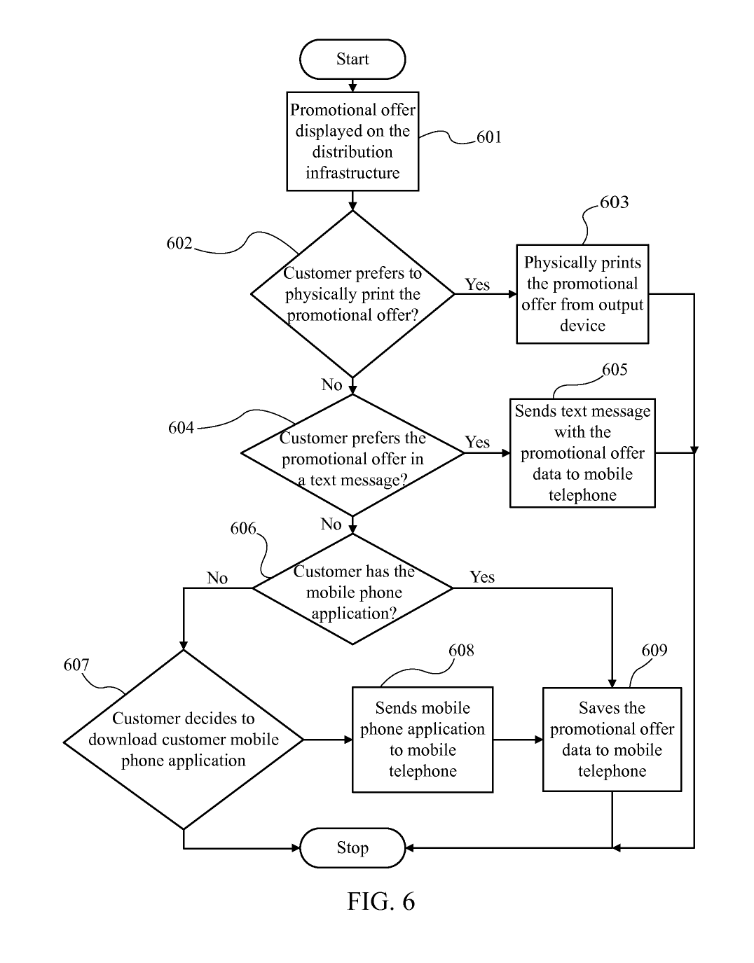

### DETAIL DESCRIPTIONS OF THE INVENTION

All illustrations of the drawings are for the purpose of describing selected versions of the present invention and are not intended to limit the scope of the present invention.

The present invention is a system and method for managing, distributing, and advertising a plurality of promotional offers. A promotional offer is a bargain or a coupon provided by an advertiser. The present invention comprises an advertiser management infrastructure 101, a main system 102, a distribution infrastructure 104, and a sales lead database 103. The main system 102 allows the present invention to manage and distribute the plurality of promotional offers. The advertiser management infrastructure 101 allows a plurality of advertisers to access the main system 102. Likewise, the distribution infrastructure 104 allows a plurality of customers to access the main system 102. The sales lead database 103 allows the advertiser to save and access a set of data obtained from the main system 102.

The advertiser management infrastructure 101 allows the plurality of advertisers to interact with the main system 102. The advertiser can input the promotional offer into the main system 102 with the advertiser management infrastructure 101. The advertiser management infrastructure 101 also allows the advertiser to start a pay-per-print campaign by paying a subscription fee. The pay-per-print campaign allows the main system 102 to present the promotional offer to a plurality of customers on the distribution infrastructure 104. The subscription fee pays for the appearances by the promotional offer on the distribution infrastructure 104 for a set period of time. If the advertiser pays a larger subscription fee, then the promotional offer would be allowed to appear on the distribution infrastructure 104 for a longer set period of time. In addition to the subscription fee, the advertiser would agree to pay a bid every time a customer printed the promotional offer. Printing the promotional offer can be done either by an output device such as a printer or by saving the promotional offer to a personal storage device such as a mobile telephone. In particular instances, printing the promotional offer can also be done by viewing an appearance promotional offer. The appearance promotional offer is a promotional offer that the customer does not need to present to the retailer in order to take advantage of the promotional offer. The main system 102 regulates the pay-per-print campaign until the end of the set period of time. The advertiser achieves a financial return on the pay-per-print campaign when the customer buys the product or service advertised in the promotional offer, which is known as a conversion. The advertiser can analyze the set of data saved on the sales lead database 103 to adjust their bid.

The distribution infrastructure 104 is extensive and allows many customers to access the main system 102 from a variety of locations. The distribution infrastructure 104 comprises a website 107, a mobile phone application 106, and a plurality of kiosks 105. The website 107 allows the plurality of customers to access the main system 102 from any personal computer. The plurality of customers can also download the mobile phone application 106 onto their mobile telephones to access the main system 102. The plurality of kiosks 105 allows the plurality of customers to access the main system 102 from different retail locations. The plurality of customers interacts with the mobile phone application 106 and the plurality of kiosks 105 through a touch screen, which has the ability to display a category screen and a promotional offer screen. The category screen displays a list of categories, which is organized by how relevant a category is to the location of the distribution infrastructure 104. For example, if the customer accessed a kiosk at a grocery store, then the list of categories would be organized to present the categories dealing with groceries in a more prominent position on the category screen. Another example is if the customer accessed the mobile phone application 106 at a sports equipment store, then the list of categories would be organized to present the categories dealing with sports equipment in a more prominent position on the category screen. Once a category is chosen, the touch screen displays the promotional offer screen. The promotional offer screen presents a list of promotional offers specific to the chosen category. The list of promotional offers is organized with an existing listing strategy so that certain promotional offers have a more prominent listing position on the promotional offer screen. The existing listing strategy is implemented by the main system 102.

The main system 102 manages and distributes the plurality of promotional offers between the advertiser management infrastructure 101 and the distribution infrastructure 104. The main system 102 consists of an offer database, an offer engine, a tracking engine, a customer profiling engine, a listing engine, and a bidding engine. The offer database stores the plurality of promotional offers within the main system 102. The offer database will organize the plurality of promotional offers according to specific promotional offer data. The promotion data includes the advertiser's name, the content, the expiration date, the barcode, and/or the promotion code. The offer engine determines key factors of the plurality of promotional offers that contribute to the existing listing strategy. The offer engine comprises an inventory integration engine, a label optimization engine, and a location optimization engine. The inventory integration engine computes an inventory factor for each of the plurality of promotional offers. The inventory factor is a quantity the depends on the difference between the number of times that the promotional offer has been printed off of the distribution infrastructure 104 and the number of unbought products or services advertised by the promotional offer. The inventory factor is one while the difference between the number of printed promotional offers and the number of unbought products or services remains above a threshold specified by the advertiser. The inventory factor becomes zero once the difference between the number of printed promotional offers and the number of unbought products or services goes below the threshold specified by the advertiser. The label optimization engine determines the attractiveness factor for each of the plurality of promotional offer. The attractiveness factor is a quantity that represents the appeal of the promotional offer. For example, “buy one, get one free” is a promotional offer with a greater appeal than “25% off”, and, thus, the attractiveness factor of “buy one, get one free” is greater than the attractiveness factor of “25% off.” The location optimization engine computes a location factor for each of the plurality of promotional offers. The location factor is a quantity that depends on how far away the promotional offer is being presented on the distribution infrastructure 104 in relation to a location relevant to the promotional offer. For example, the location factor for a bread coupon presented at a kiosk 2 miles away from a bakery is smaller than the location factor for the beard coupon presented at another kiosk 3 miles away from the bakery. The location factor for the website 107 is one because the website 107 can be accessed from any personal computer and is not relevant to a particular location. The location optimization engine also allows the main system 102 to find the optimal location for each of the plurality of promotional offers by determining which of the plurality of promotional offers has the lowest location factor for a particular location.

The other components of the main system 102 do not deal with the characteristics of the promotional offer. The tracking system computes the past print through factor for each of the plurality of promotional offers. The past print through factor is a quantity that depend on a print through rate. The past print through factor increases as the print through rate increases and decreases as the past print through rate decreases. The print through rate is the ratio between the number of appearances by the promotional offer on the distribution infrastructure 104 and the number of times that the promotional offer has been printed of the distribution infrastructure 104. For example, a coupon that has appeared 5 times on the distribution infrastructure 104 and gets printed 3 times has a larger print through rate than another coupon that has appeared 5 times on the distribution infrastructure 104 and gets printed once. The customer profiling engine creates a customer profile for each of the plurality of the customers. The customer profile catalogs each of the plurality of customers with their mobile telephone number because a customer does not change their mobile telephone number too often. The customer profile records a plurality of saved promotional offers for each of the plurality of customers. The plurality of saved promotional offers is the promotional offers saved by the customer on the main system 102 from a previous visit to the distribution infrastructure 104. From the plurality of saved promotional offers, the customer profiling engine determines the products and services that each of the plurality of customers find most appealing, which allows the customer profiling engine to compute a profile factor. The profile factor is a quantity that depends on how relevant the promotional offer is to the customer. For example, if the customer found products and services related to house cleaning to be the most appealing, then a promotional offer related to house cleaning would have a higher profile factor than a promotional offer related to something else. The customer profile also records the browsing history of the customer according to the categories he/she has selected on the category screen in the past, which allows the customer profiling engine to compute the browsing history factor. The browsing history factor is a quantity that depends on how relevant the promotional offer is to the browsing history of each of the plurality of customers. For example, if the customer's browser history included categories related to computers, then the browsing history factor for a promotional offer related to computers would be higher than a promotional offer related to something else. The bidding engine records the bid made by each of the plurality of advertisers, which allows the bidding engine to compute the advertiser bid factor. The bid is a monetary amount that the advertiser is willing to pay to have the plurality of customer to see their promotional offer in a more prominent position on the promotional offer screen. The advertiser bid factor is a quantity that depends on the size of the bid for the promotional offer. For example, the advertiser bid factor is higher for an advertiser willing to pay a bid of $5.00 every time their promotional offer is printed than an advertiser willing to pay a bid of $3.00 every time their promotional offer is printed.

The listing engine allows the main system 102 to execute the existing listing strategy. The existing listing strategy determines a listing position for each of the plurality of promotional offers on the list of promotional offers by means of a ranking algorithm. The ranking algorithm computes a ranking index for each of the plurality of promotional offers. The ranking index is calculated with a plurality of ranking algorithm factors. The plurality of ranking algorithm factors includes the inventory factor, the labeling factor, the location factor, the past print through factor, the profile factor, the browsing history factor, and the advertiser bid factor. The ranking index is proportional to the inventory factor, the labeling factor, the past print through factor, the profile factor, the browsing history factor, and the advertiser bid factor. The ranking index is inversely proportional to the location factor. Once the ranking index is assigned to each of the plurality of promotional offers, the listing engine will produce the list of promotional offers for a specific category. The list of promotional offers will be arranged according to the ranking index of each of the plurality of promotional offers. Thus, a promotional offer with a higher ranking index will receive a more prominent listing position on the promotional offer screen than a promotional offer with a lower ranking index.

The main system 102 implements a method for managing a plurality of pay per print campaigns by the main system. The method for managing the plurality of pay per print campaigns begins by collecting the set of data from a number of different sources. The set of data consists of a performance data, a profiling data, a constraint data, and a time data. From the tracking engine, the main system 102 collects performance data from each of the plurality of pay per print campaigns 201. The performance data includes the print through rate for each of the plurality of promotional offer. From the customer profiling engine, the main system 102 collects profiling data for each of the plurality of customers 202. The profiling data includes the customer profile and the browsing history of each of the plurality of customers as discussed above. From the offer engine, the main system 102 collects the constraint data from each of the plurality of pay per print campaigns 203. The constraint data includes the difference between the number of printed promotional offers and the number of unbought products and services for each of the plurality of promotional offers from the inventory integration engine. The constraint data also includes the optimal location for each of the plurality of promotional offers from the location optimization engine. From the distribution infrastructure 104, the main system 102 obtains the time data for each of the plurality of customers 204. The time data includes when and what date each of the plurality of customers accessed the main system 102 from the distribution infrastructure 104. The second step in the method for managing the plurality of pay per print campaign is to analyze the performance data, the profiling data, the constraint data, and the time data 205. Analyzing the set of data along with the existing listing strategy allows the main system 102 to formulate an intermediate listing strategy. The intermediate listing strategy rearranges the ranking index for each of the plurality of promotional offers according to the analysis of the set of data. In the third step, the intermediate listing strategy is modified with an optimization algorithm to establish an optimal listing strategy 301. The optimization algorithm will be described later. The fourth step is to use the optimal listing strategy to update the ranking index for each of the plurality of promotional offers 302 and to display the new list of promotional offers 303 on the distribution infrastructure 104, which will lead to more conversions by the plurality of customers. After, the fourth step, method for managing a plurality of pay per print campaigns by the main system comes to an end.

The optimization algorithm described in the method for managing the plurality of pay per print campaigns is also a method. The first step of the optimization algorithm is to retrieve the print through rate for each of the plurality of pay per print campaign 401. The print through rate is based on the current listing position given to each of the plurality of promotional offers. The second step is to calculate a change factor for the current listing position 402. The change factor moves the current listing position up or down the list of promotional offers. The third step is to modify the current listing position with the change factor to find other listing positions that would increase the print through rate 403. The last step is to determine which of the other listing positions is the optimal listing position that would maximize the print through rate for each of the plurality of promotional offers 404. The revenue collected by the main system 102 increases as the main system 102 maximizes the print through rate of each of the plurality of promotional offers. Thus, the optimization algorithm is beneficial to both the advertiser and the present invention because the advertiser produces more opportunities for the promotional offer to become a conversion and the present invention increases its revenue.

For the customer, the present invention has three methods of interaction. One method related to the customer is logging into the main system 102 and dealing with the plurality of promotional offers. The first step in the method is to determine if the customer has a customer profile 501 on the main system 102. The second step depends on whether or not the customer has a customer profile on the main system 102. If the customer has a customer profile, then the distribution infrastructure 104 will use the customer's mobile telephone number to retrieve the customer profile 505 from the main system 102. If the customer does not have a customer profile, then the distribution infrastructure 104 will retrieve the customer's mobile telephone number 502, which the customer profiling engine will catalog and send a verification notice to the customer's mobile telephone 503. The distribution infrastructure 104 will ask for the verification notice from the customer 504 to have the customer profiling engine create a customer profile on the main system 102. The third step is to determine if the customer has a saved promotional offer on their customer profile 506. The fourth step depends on whether or not the customer has a saved promotional offer on their customer profile. If the customer has a saved promotional offer, then the distribution infrastructure 104 retrieves the saved promotional offer 510 from the main system 102 and presents the saved promotional offer to the customer 511. If the customer does not have a saved promotional offer, then the distribution infrastructure 104 retrieves a list of promotional offers from the listing engine 507 and displays the list of promotional offers to the customer 508. The fifth step is an option to determine if the customer wants a promotional offer from the list of promotional offers to become a saved promotional offer 509 on the customer profile. After the fifth step, the method of logging into the main system 102 and dealing with the plurality of promotional offers comes to an end.

Another method related to the customer is saving an external promotional offer to the customer profile. The external promotional offer is a promotional offer that an advertiser did not place within the present invention. The external promotional offer can found in places such as other websites, newspapers, or magazines. The first step is for the customer to find an external promotional offer that appeals to the customer. Again, the first step is done by the customer searching through places such as websites, newspapers, or magazines. The second step is for the customer to use the distribution infrastructure 104 to store the promotional offer data from the external promotional offer to the customer profile, which allows the external promotional offer to become a saved external promotional offer. For example, the promotional offer data from the external promotion offer can saved to the customer profile by either a right-click option off of another website or scanned in from a newspaper. The saved external promotional offer is saved to the customer profile like all other saved promotional offers, except the saved external promotional offer can be shared with the plurality of customers. The third step is for the customer to decide whether or not to share the saved external promotional offer. The saved external promotional offer can be shared by means of social network, email, blogging, electronic messaging, or other such means. After the fourth step, the method of saving an external promotional offer comes to an end.

The last method related to the customer is to obtain a selected promotional offer, which is displayed on the promotional offer screen 601. The first step is to ask whether or not the customer prefers to physically print the selected promotional offer 602 from the distribution infrastructure 104. If the customer prefers to physically print the selected promotional offer, then the distribution infrastructure 104 prints the promotional offer 603. If the customer prefers not to physically print the selected promotional offer, then the customer proceeds to the next step. The second step is to ask whether or not the customer prefers the main system 102 to send a text message with the selected promotional offer 604. If the customer prefers the selected promotional offer to be displayed as a text message, then the main system 102 will retrieve the customer's mobile telephone number from the customer profile and send the text message with the selected promotional offer to the customer's mobile telephone 605. If the customer prefers not to have the selected promotional offer be displayed as a text message, then the customer proceeds to the next step. The third step is to ask whether or not the customer has the mobile phone application 106 on their mobile telephone 606. If the customer has the mobile phone application 106, then the main system 102 will send the promotional offer to mobile phone application 106 on the customer's mobile telephone 609. If the customer does not have the mobile phone application 106, then the distribution infrastructure 104 will ask the customer to download the mobile phone application 106 to the customer's mobile telephone 607. If the customer downloads the mobile phone application 106 to their mobile telephone 608, then the customer will then be able to access the main system 102 with the mobile phone application 106 and be able to view and save the selected promotional offer to their mobile telephone 609. After the third step, the method for obtaining a selected promotional offer from the promotional offer screen comes to an end.

Although the invention has been explained in relation to its preferred embodiment, it is to be understood that many other possible modifications and variations can be made without departing from the spirit and scope of the invention as hereinafter claimed.

What is claimed is:

1. A method of managing, distributing, and advertising a plurality of promotional offers by executing computer-executable instructions stored on a non-transitory computer-readable medium, the method comprises the steps of:
obtaining a plurality of ranking algorithm factors for a promotional offer;
determining a ranking index for the promotional offer depending on the plurality ranking algorithm factors;
assigning of the ranking index to the promotional offer determined by the plurality of ranking algorithm factors;
ordering a plurality of promotional offers based on the ranking index of each of the plurality of promotional offer;
producing a list of promotional offers from the ordered plurality of promotional offers; and
displaying the list of promotional offers on a promotional offer screen.

2. The method of managing, distributing, and advertising a plurality of promotional offers by executing computer-executable instructions stored on a non-transitory computer-readable medium of claim 1,
wherein the promotional offer screen provides the means to store or send the promotional offer data to a mobile telephone; and
sending the promotional offer data to an output device, wherein the output device can be a printer.

3. The method of managing, distributing, and advertising a plurality of promotional offers by executing computer-executable instructions stored on a non-transitory computer-readable medium of claim 2,
tracking of performance data for each of the promotional offers, wherein the performance data includes the ratio between the number of times the promotional offer data is stored in the mobile telephone, sent to the output device, or viewed as an appearance promotional offer and the number of times the promotional offer data is displayed;
tracking of profiling data for each of the promotional offers, wherein the profiling data includes browsing history, mobile phone numbers, and stored promotional offer data;
tracking of constraint data for each of the promotional offers, wherein the constraint data includes the optimal location for the promotional offer and the difference between the number of times the promotional offer data is stored to the mobile telephone or sent to the output device and the number of available unbought products or services associated with the promotional offer; and
tracking of time data for each of the promotional offers, wherein the time data includes the time and date the promotional offer data is displayed.

4. The method of managing, distributing, and advertising a plurality of promotional offers by executing computer-executable instructions stored on a non-transitory computer-readable medium of claim 3,
calculating the ranking index by means of the equation:
$$R = \frac{B \times PT \times P \times H \times A \times IN}{L}$$
wherein the ranking index R associated with the promotional offer is proportional to an advertiser bid factor B, a past print through factor PT, a profile factor P, a user browsing history factor H, an attractiveness factor A, an inventory factor IN, and inversely proportional to a location factor L.

5. The method of managing, distributing, and advertising a plurality of promotional offers by executing computer-executable instructions stored on a non-transitory computer-readable medium of claim 4,
providing means to input a new bid, wherein the new bid is directly proportional to the advertiser bid factor; and
wherein the past print through factor is directly proportional to the performance data.

6. The method of managing, distributing, and advertising a plurality of promotional offers by executing computer-executable instructions stored on a non-transitory computer-readable medium of claim 1,
optimizing the list of promotion offers by maximizing a print through rate for each of the plurality of promotional offers;
maximizing the print through rate for each of the plurality of promotional offers by changing the ranking index of the promotional offer by a change factor;
determining the change factor of each of the plurality of promotional offers increases the print through rate of the promotional offer;
finding the change factor for each of the plurality of promotional offers producing the optimal print through rate for each of the plurality of promotional offers;
reassigning of ranking index of each of the plurality of promotional offers based on maximization of the print through rate of each of the plurality of promotional offers; and
updating the list of promotional offers based on the reassigned ranking index for each of the plurality of promotional offers.

7. A method of use for managing, distributing, and advertising a plurality of promotional offers,
starting a pay per print campaign by paying a subscription fee to a main system through an advertiser distribution infrastructure, wherein the pay per print campaign associates with a promotional offer;
specifying a bid for the promotional offer;
specifying a threshold for the promotional offer;
sharing the promotion offer by means of the distribution infrastructure;
retrieving a performance data, a profiling data, a constraint data, and a time data;
storing the performance data, the profiling data, the constraint data, and the time data on a sales lead database; and
analyzing the performance data, the profiling data, the constraint data, and the time data to determine a new bid.

8. The method of use for managing, distributing, and advertising a plurality of promotional offers as claimed in claim 7,
paying the bid every time the promotional offer data is stored in a mobile telephone, sent to an output device, or viewed as an appearance promotional offer; and
wherein the promotional offer can be distributed on a website, a mobile phone application, or a plurality of kiosks.

9. The method of use for managing, distributing, and advertising a plurality of promotional offers as claimed in claim 7,
viewing the performance data, the profiling data, the constraint data, and the time data stored on the sales lead database with the advertiser management infrastructure; and
placing a new bid according to an increase or decrease in performance data.

10. A method of use for managing, distributing, and advertising a plurality of promotional offers,
accessing a main system with a mobile telephone number through a distribution infrastructure;
accessing a customer profile stored on the main system;
accessing a promotional offer screen with a list of promotional offers; and
outputting a promotional offer from the distribution infrastructure.

11. The method of use for managing, distributing, and advertising a plurality of promotional offers as claimed in claim 10,
providing the mobile telephone number granting access to a customer profile on the main system, wherein not providing the mobile telephone number prompts a registration process.
entering the mobile telephone number into the main system from the distribution infrastructure initiates the registration process;
receiving a verification notice from main system on a mobile telephone;
entering the verification notice into the distribution infrastructure; and
obtaining the customer profile from the main system terminates the registration process.

12. The method of use for managing, distributing, and advertising a plurality of promotional offers as claimed in claim 10,
having a saved promotional offer in the customer profile displays the saved promotional on the distribution infrastructure, wherein not having a saved promotional offer prompts a listing process;
receiving a list of promotional offers displayed on the distribution infrastructure initiates the listing process;
selecting the promotional offer from the promotional offer screen; and
displaying the promotional offer on the distribution infrastructure terminates the listing process.

13. The method of use for managing, distributing, and advertising a plurality of promotional offers as claimed in claim 12,
wherein saving the promotional offer displayed on the distribution infrastructure means saving the promotional offer data to the customer profile.

14. The method of use for managing, distributing, and advertising a plurality of promotional offers as claimed in claim 12,
wherein outputting the promotional offer displayed on the distribution infrastructure means printing the promotion offer with an output device.

15. The method of use for managing, distributing, and advertising a plurality of promotional offers as claimed in claim 12,
wherein outputting the promotional offer displayed on the distribution infrastructure means receiving a text message on the mobile telephone with the promotional offer data.

16. The method of use for managing, distributing, and advertising a plurality of promotional offers as claimed in claim 12,
wherein the outputting the promotional offer displayed on the distribution infrastructure means saving the promotional offer data to the mobile telephone with a mobile phone application;
downloading the mobile phone application from the main system; and
saving the promotional offer data from the main system onto the mobile telephone with the mobile phone application.

17. The method of use for managing, distributing, and advertising a plurality of promotional offers as claimed in claim 10,
saving of an external promotional offer to the customer profile, wherein the saving process integrates the external promotional offer with the existing promotional offers.
